(19) United States
(12) Patent Application Publication
(10) Pub. No.: US 2008/0029124 A1
(43) Pub. Date: Feb. 7, 2008

(54) ELECTRIC SWITCH CLEANING APPARATUS AND METHOD

(76) Inventor: Kenneth C. Schroeder, Porter, IN (US)

Correspondence Address: HARTMAN & HARTMAN, P.C., 552 EAST 700 NORTH, VALPARAISO, IN, 46383, US

(21) Appl. No.: 11/834,481

(22) Filed: Aug. 6, 2007

Related U.S. Application Data
(60) Provisional application No. 60/821,477, filed on Aug. 4, 2006.

(51) Int. Cl. B08B 6/00

(52) U.S. Cl. 134/1; 134/58 R

(57) ABSTRACT

An electric switch cleaning apparatus and method. The apparatus includes a transformer adapted to deliver AC voltage less than what is lethal to a human, a voltage-providing component for providing AC voltage to the transformer, connectors for temporarily making electrical connections to an electrical switch, a current-conducting component coupled to the transformer for carrying AC current from the transformer to the connectors, and a device associated with the current-conducting component for providing a visual indication that AC current is flowing through the switch. In use, the electrical connectors are connected across the switch, power is delivered with the voltage-providing component to the transformer so that the current-carrying component delivers AC current from the transformer to the connectors and through the switch, and the switch is cycled until AC current flows through the switch.

### CROSS REFERENCE TO RELATED APPLICATIONS

This application claims the benefit of U.S. Provisional Application No. 60/821,477, filed Aug. 4, 2006, the contents of which are incorporated herein by reference.

### BACKGROUND OF THE INVENTION

The present invention generally relates to electrical equipment. More particularly, this invention relates to an apparatus and method for removing oxidation and other contamination from the contact surfaces of a switch to improve or restore electrical continuity through the switch when closed.

Buzzers and similar signaling devices are widely used to notify occupants of apartment complexes. In a typical unit, multiple buttons are located on a panel, and each button is individually assigned to activate a buzzer within an apartment. The buttons are often single-pole, single-throw (SPST) switches that momentarily close the electrical circuits of their respective buzzers. One terminal of the switch is typically wired to a terminal on a transformer, which steps down the high AC voltage electrical power supplied to residential buildings (e.g., 120-240-volt AC in the US) to a lower voltage, for example, about 3 to about 30 volts.

Low voltage switches of the type described above can become inoperable from oxidation and other contamination and degradation. Particularly vulnerable are buzzer switches located outdoors and therefore exposed to moisture and airborne contaminants. In some climates, apartment buzzer switches located outdoors are typically replaced every few years because the switches are no longer operable due to corrosion. It would be desirable if the lives of these switches could be extended to reduce maintenance costs.

### BRIEF SUMMARY OF THE INVENTION

The present invention provides an electric switch cleaning apparatus and switch cleaning method.

According to a first aspect of the invention, the electric switch cleaning apparatus includes a transformer adapted to deliver AC voltage than what is lethal to a human, a voltage-providing component for providing AC voltage to the transformer, first and second connectors for temporarily making electrical connections to an electrical switch, a current-conducting component coupled to the transformer for carrying AC current from the transformer to the first and second connectors, and a resistor and a lamp arranged in parallel within the current-conducting component.

According to a second aspect of the invention, the electric switch cleaning apparatus is employed to clean an electrical switch by electrically connecting the first electrical connector to a wire of a switch system containing the electrical switch and electrically connecting the second electrical connector to a terminal of the electrical switch whose wire has been removed, delivering power with the voltage-providing component to the transformer so that the current-carrying component delivers AC current from the transformer to the first and second electrical connectors and through the electrical switch, and then cycling the electrical switch on and off until the lamp lights in response to the AC current flowing through the electrical switch as a result of the AC current from the transformer arching across contacts of the electrical switch and removing corrosion.

In view of the above, it can be seen that the invention provides an uncomplicated apparatus and method that is capable of cleaning low voltage electrical switches, thereby extending the life of a switch beyond that which would otherwise occur because of corrosion and contamination.

Other objects and advantages of this invention will be better appreciated from the following detailed description.

### BRIEF DESCRIPTION OF THE DRAWINGS

FIG. 1 is a perspective view of an electric switch cleaning apparatus according to an embodiment of the invention.

FIG. 2 is an electrical schematic of the apparatus of FIG. 1.

### DETAILED DESCRIPTION OF THE INVENTION

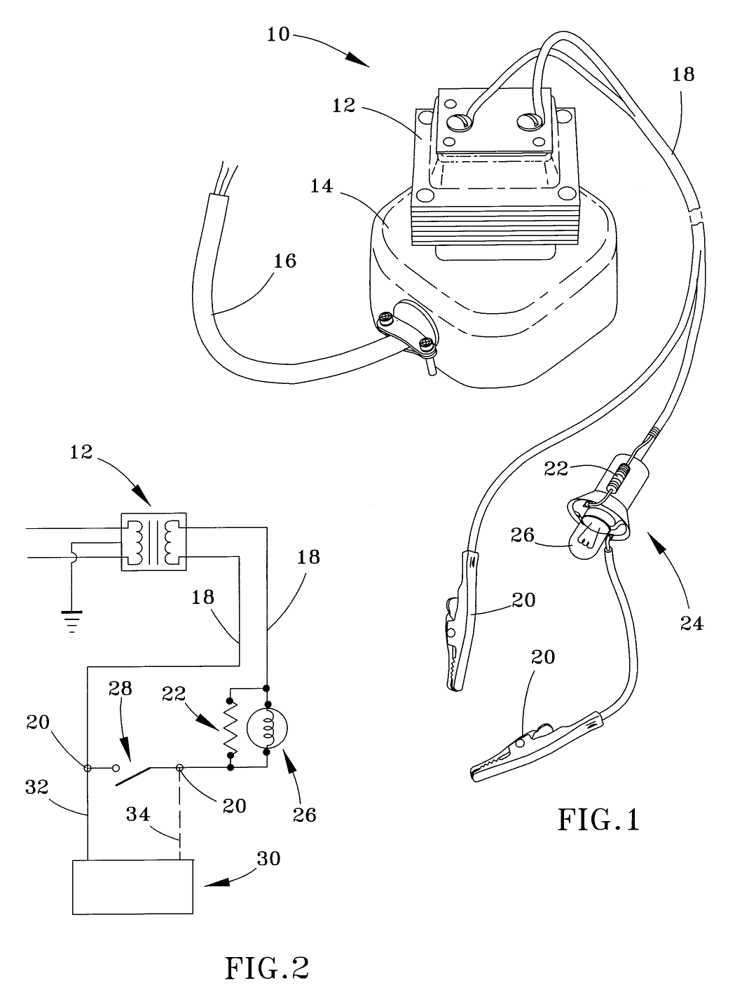

FIGS. 1 and 2 show an electric switch cleaning apparatus 10 adapted for cleaning electrical switches, a particular but nonlimiting example of which is a low voltage switch wired to activate a buzzer of an apartment complex. The apparatus 10 is shown as including a transformer 12, a wiring box 14 on which the transformer 12 is mounted for convenience, a power cable 16 coupled to the box 14 to provide AC voltage to the transformer 12, and low voltage paired cords 18 coupled to the transformer 12 for carrying AC current from the transformer 12 to a pair of alligator clips 20. The cable 16 is preferably a three-wire cord that grounds the transformer 12 and wiring box 14.

The transformer 12 is intended to deliver AC current at a level sufficient to arch across the contacts of a low voltage switch. A suitable voltage level for this purpose is at least about 24VAC, but preferably below a level that could prove lethal to a human. A nonlimiting example of a suitable voltage level is about 28VAC. An example of a suitable transformer is commercially available from Nutone under product number 401T, which has a 24V and 40 W rating and a 1.5 amp maximum limit above which voltage in the transformer 12 falls, thereby avoiding damage to the transformer 12 and injury to the user.

The alligator clips 20 are attached to the terminal ends of the low voltage paired cords 18, and are used to connect the apparatus 10 to a low voltage switch 28 (FIG. 2) that requires cleaning. One of the cords 18 is shown as having, arranged in parallel, a resistor 22 and a low voltage lamp-and-socket set 24. The lamp 26 of the set 24 may be, for example, of a type that has a 40 milliamp draw, such as an 1829. The resistor 22 may be a 220 ohm resistor with a draw of approximately 160 milliamps, resulting in a total draw of about 200 milliamps through the cord 18. The purpose of the lamp 26 is to provide the user with a visual indication that AC current is flowing through the switch 28, and for this reason the lamp 26 is preferably located in proximity to its associated clip 20 as shown in FIG. 1 so that the user can easily observe the lamp 26 while actuating the switch 28. Those skilled in the art will appreciate that other combinations of lamps and resistors, as well as other electrical devices, could also be used to achieve this purpose.

In use, either of the clips 20 is attached to a wire 32 of the switch system 30 containing the switch 28 to be cleaned, and the remaining clip 20 is attached to a terminal of the switch 28 whose wire 34 has been removed so that the current provided by the apparatus 10 through the clips 20 is applied solely through the switch 28 and not through other electrical devices within the electric circuit containing the switch 28. Power is then provided to the transformer 12, and the switch 28 is preferably cycled on and off several times until the lamp 26 lights in response to AC current flowing through the switch 28 as a result of the AC current from the transformer 12 arching across the contacts of the switch 28, the effect of which is the removal of corrosion and other contaminants from the contacts of the switch 28.

While the invention has been described in terms of a specific embodiment, it is apparent that other forms could be adopted by one skilled in the art. For example, the physical configuration of the apparatus 10 could differ from that shown, for example, certain components of the apparatus 10 could be housed within an enclosure. Furthermore, components and processes other than those noted could be used. As a particular example, while alligator clips 20 are shown and preferred as lowcost devices for quickly making temporary electrical connections, it is foreseeable that functionally-equivalent devices could be used to make the desired temporary electrical connections. Finally, the apparatus 10 could be used to clean switches of a variety of other electrical systems, including intercom systems, central vacuum systems, and vending machines. Therefore, the scope of the invention is to be limited only by the following claims.

1. An electric switch cleaning apparatus adapted for cleaning an electrical switch, the apparatus comprising:
a transformer adapted to deliver AC voltage less than what is lethal to a human;
means for providing AC voltage to the transformer;
first and second means for temporarily making electrical connections to an electrical switch;
means coupled to the transformer for carrying AC current from the transformer to the first and second electrical connection means; and
means associated with the current-carrying means for providing a visual indication that AC current is flowing through the electrical switch.

2. The electric switch cleaning apparatus according to claim 1, wherein the transformer is adapted to deliver at least about 24VAC.

3. The electric switch cleaning apparatus according to claim 1, wherein the transformer has a 1.5 amp maximum limit above which voltage in the transformer falls to thereby avoid injury to a user.

4. The electric switch cleaning apparatus according to claim 1, wherein the first and second electrical connection means comprises two alligator clips.

5. The electric switch cleaning apparatus according to claim 1, wherein the voltage-providing means comprises a power cable.

6. The electric switch cleaning apparatus according to claim 1, wherein the current-carrying means comprises a pair of cords, one of the cords containing the resistor and the lamp.

7. The electric switch cleaning apparatus according to claim 1, wherein the lamp has an approximately 40 milliamp draw.

8. The electric switch cleaning apparatus according to claim 1, wherein the resistor has a resistance of about 220 ohms.

9. The electric switch cleaning apparatus according to claim 1, wherein the visual indication means comprises a resistor and a lamp arranged in parallel in the current-carrying means.

10. A method for cleaning an electrical switch, the method comprising:
connecting an electric switch cleaning apparatus to the electrical switch, the apparatus comprising a transformer adapted to deliver AC voltage less than what is lethal to a human, means for providing AC voltage to the transformer, first and second electrical connection means for temporarily making electrical connections to an electrical switch, and means coupled to the transformer for carrying AC current from the transformer to the first and second electrical connection means, the current-carrying means comprising a resistor and a lamp arranged in parallel;
electrically connecting the first electrical connection means to a wire of a switch system containing the electrical switch and electrically connecting the second electrical connection means to a terminal of the electrical switch whose wire has been removed;
delivering power with the voltage-providing means to the transformer so that the current-carrying means delivers AC current from the transformer to the first and second electrical connection means and through the electrical switch to be cleaned; and
cycling the electrical switch on and off until a visual indication is received that AC current is flowing through the electrical switch as a result of the AC current from the transformer arching across contacts of the electrical switch and removing corrosion.
